(19) United States
(12) Patent Application Publication
(10) Pub. No.: US 2016/0102748 A1
(43) Pub. Date: Apr. 14, 2016

(54) RACK AND RACK MANUFACTURING METHOD

(71) Applicant: NITTA CORPORATION, Osaka (JP)

(72) Inventors: Kenichiro Aoki, Nara (JP); Yoshiharu Kiyohara, Nara (JP); Takehito Dei, Nara (JP); Yoji Ishizaki, Nara (JP); Yasuhiro Aoki, Nara (JP)

(21) Appl. No.: 14/975,509

(22) Filed: Dec. 18, 2015

Related U.S. Application Data
(63) Continuation of application No. PCT/JP2014/064915, filed on Jun. 5, 2014.

(30) Foreign Application Priority Data
Jun. 24, 2013 (JP) 2013-131389

(51) Int. Cl. F16H 55/26

(52) U.S. Cl. CPC F16H 55/26

(57) ABSTRACT

A rack includes a plurality of thin plates laminated with each other, wherein each of the plurality of thin plates is formed with a set of rack teeth, and adjacent thin plates, which are laminated adjacently to each other, of the plurality of thin plates are fixed together such that respective rack-tooth positions of the adjacent thin plates are displaced from each other in axial directions of adjacent sets of rack teeth.

### CROSS REFERENCE TO RELATED APPLICATIONS

This is a continuation application of International Patent Application No. PCT/JP2014/064915 filed on Jun. 5, 2014 claiming priority upon Japanese Patent Application No. 2013-131389 filed on Jun. 24, 2013, of which full contents are incorporated herein by reference.

### BACKGROUND

1. Technical Field

The present disclosure relates to a rack having a plurality of thin plates laminated with each other, and a method of manufacturing the same.

2. Description of the Related Art

An example of such a sort of rack has been disclosed in Patent Document 1. Each of the racks disclosed in the patent document has been a structure having a plurality of thin plates laminated with each other, where each of the plurality of thin plates is formed with rack teeth such that a tooth trace thereof is in a direction perpendicular to an axial direction. That is to say, these racks have served as spur racks, and have been used together with spur pinions to make a rack-and-pinion mechanism.

### PRIOR ART DOCUMENTS

### Patent Documents

Patent Document 1: Japanese Patent Application Publication No. 2010-89964

### Problem to be Solved

It has been well known that the rack-and-pinion mechanism made by a helical rack and a helical pinion or made by a herringbone rack and a herringbone pinion generates lower tooth-hit noise in comparison with the case of the rack-and-pinion mechanism made by a spur rack and a spur pinion.

In comparison with spur racks, however, helical racks are difficult to manufacture, and herringbone racks are still more difficult to manufacture, due to their complicated forms, which has been a problem.

### BRIEF SUMMARY

The objective of the present disclosure is to provide a rack such as helical and herringbone racks capable of being easily manufactured even though it is usually more difficult to manufacture in comparison with a spur rack, and a method of manufacturing the rack.

### Means for Solving Problems

[1] A rack according to the present disclosure is characterized in that the rack includes a plurality of thin plates laminated with each other, wherein each of the plurality of thin plates is formed with a set of rack teeth, and adjacent thin plates, which are laminated adjacently to each other, of the plurality of thin plates are fixed together such that respective rack-tooth positions of the adjacent thin plates are displaced from each other in axial directions of adjacent sets of rack teeth.

According to the construction of [1] above, the plurality of thin plates are laminated so that their respective sets of rack teeth can be displaced from each other in axial directions of the respective sets of rack teeth, thereby enabling the formation of racks in arbitrary shapes, and as a result, it becomes easy to manufacture racks in complicated shapes, which have been difficult thus far to manufacture.

[2] The rack according to the present disclosure including the construction of [1] above is characterized in that a plurality of sets of rack teeth are covered with an abrasion-resistant and friction-resistant member.

Due to the construction of [1] above, a relative displacement between the plurality of sets of rack teeth in the axial directions causes unevenness between the plurality of sets of tooth flanks of rack teeth, against which the improvement of abrasion and friction resistance may be required. According to the construction of [2] above, however, this problem can be solved because the plurality of sets of rack teeth are covered with the member of the improved abrasion and friction resistance.

[3] A rack manufacturing method according to the present disclosure is characterized in that the method includes the steps of: laminating a plurality of thin plates, each of which is formed with a set of rack teeth, with each other; and fixing a plurality of laminated thin plates together such that respective rack-tooth positions of adjacent thin plates, which are laminated adjacently to each other, of the plurality of laminated thin plates are displaced from each other in axial directions of adjacent sets of rack teeth.

According to the construction of [3] above, the plurality of thin plates are laminated so that the adjacent sets of rack teeth of the adjacent thin plates, respectively, can be displaced from each other in the axial directions, thereby enabling the formation of racks in arbitrary shapes, and as a result, it becomes easy to manufacture racks in complicated rack shapes, which have been difficult thus far to manufacture.

[4] The rack manufacturing method according to the present disclosure including the construction of [3] above is characterized in that the method still further includes the step of covering a plurality of sets of rack teeth of the plurality of laminated thin plates, respectively, with an abrasion-resistant and friction-resistant member .

Due to the construction of [3] above, a relative displacement between the plurality of sets of rack teeth in the axial directions causes unevenness between the plurality of sets of tooth flanks of rack teeth, against which the improvement of abrasion and friction resistance may be required. According to the construction of [4] above, however, this problem can be solved because the plurality of sets of rack teeth are covered with the member of the improved abrasion and friction resistance.

### BRIEF DESCRIPTION OF THE SEVERAL VIEWS OF THE DRAWINGS

For more thorough understanding of the present disclosure and advantages thereof, the following descriptions should be read in conjunction with the accompanying drawings in which:

FIG. 1 depicts a perspective view showing a rack as an embodiment of the present disclosure.

FIG. 2 depicts a perspective view showing a thin plate.

FIG. 3 depicts a perspective view showing a plurality of thin plates laminated with each other to form a herringbone pattern of tooth traces.

FIG. 4 depicts a plan view showing a plurality of thin plates laminated with each other, where a plurality of sets of tooth tops of rack teeth are emphasized by black-colored fills to clarify a displacement between adjacent sets of rack teeth of the adjacent thin plates, respectively.

FIG. 5 depicts an explanatory view as to how a cover made of fibers impregnated with rubber or resin is adhered to a plurality of sets of rack teeth of a plurality of thin plates laminated with each other, respectively.

FIG. 6 depicts a perspective view showing a plurality of thin plates laminated with each other to form a helical pattern of tooth traces.

FIG. 7 depicts an explanatory view as to how a cover made of fibers impregnated with rubber or resin is adhered to a plurality of sets of rack teeth of a plurality of thin plates laminated with each other, respectively.

### DETAILED DESCRIPTION

Hereinafter, a rack and a rack manufacturing method of manufacturing the rack as an embodiment of the present disclosure will be described with reference to the drawings.

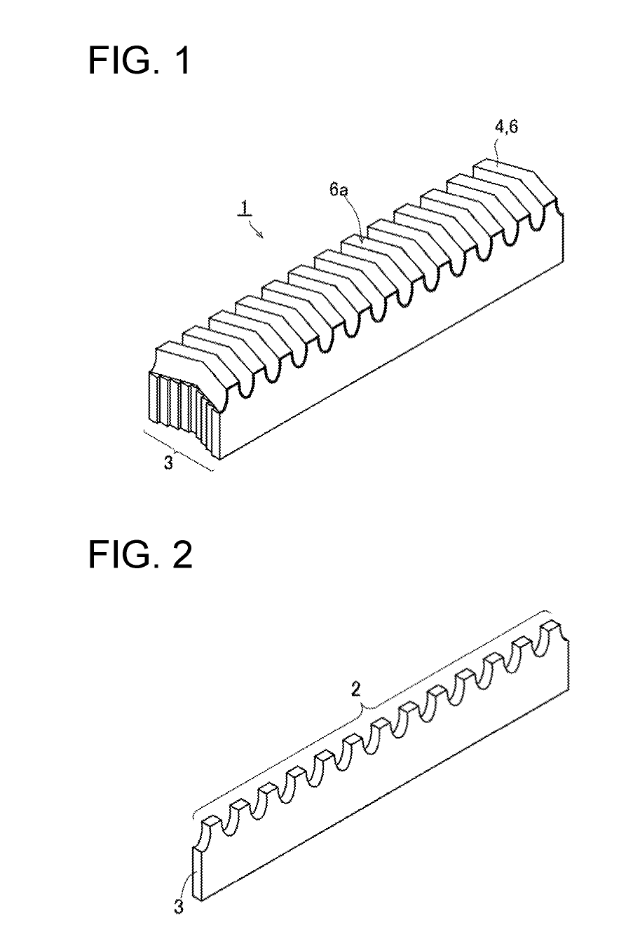

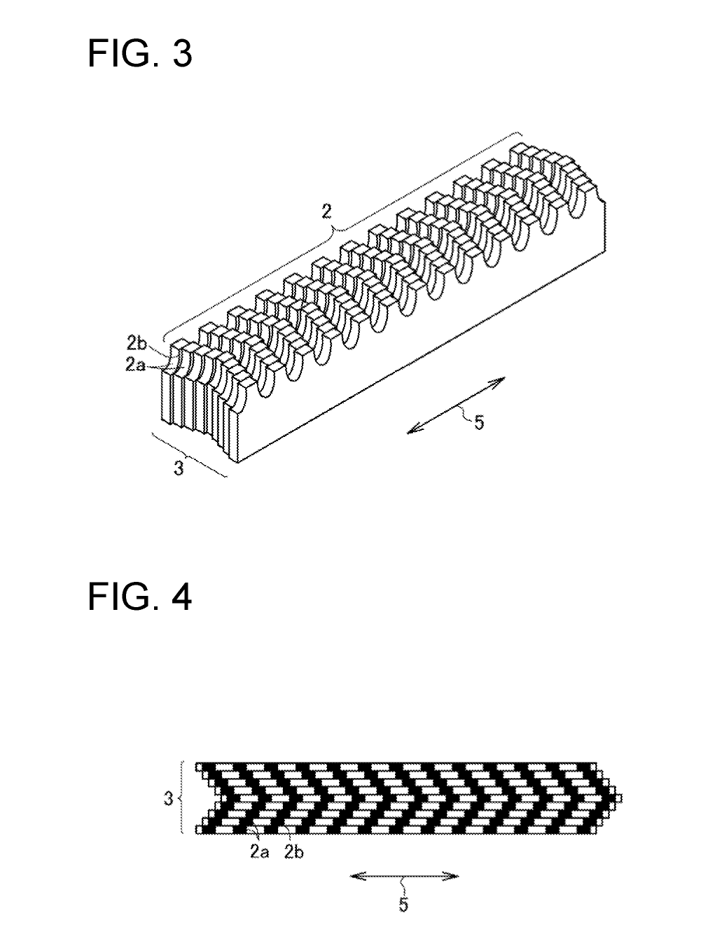

The rack (1) illustrated in FIG. 1 is manufactured by a rack manufacturing method as an embodiment of the present disclosure. This rack (1) is a herringbone rack configured such that it engages a herringbone pinion (not shown) to make a rack-and-pinion mechanism. The rack (1) has a plurality of thin plates (3) laminated with each other, of which each thin plate (3) is formed with a set of rack teeth (2) as shown in FIG. 2. As shown in FIG. 3, the rack (1) has the thin plates (3) laminated adjacently to each other and fixed together such that their respective sets of rack teeth (2) are displaced from each other in an axial direction (indicated by the double-headed arrow (5) in FIG. 3), and further has these sets of rack teeth (2) covered with an abrasion-resistant and friction-resistant member (i.e., a member that is highly resistant to abrasion and has a lower level of friction). As a member that excels in abrasion-resistance and friction-resistance, fibers (4) impregnated with rubber or resin, e.g., are adopted in an embodiment.

The rack (1) is manufactured by a method including: a thin-plate production step of producing a plurality of thin plates (3) each formed with a set of rack teeth (2); a thin-plate lamination step of laminating the plurality of produced thin plates (3) to fix them together; and a cover-adhesion step of adhering a cover (6) made of fibers (4) impregnated with rubber or resin to a plurality of sets of rack teeth (2) of the plurality of laminated and fixed thin plates (3). Hereinafter, detailed descriptions will be made of each step.

In the thin-plate production step described above, thin plates (3) each formed with a set of rack teeth (2) as shown in FIG. 2 are produced by punching a thin iron sheet. The punching die may be substantially the same in shape as the outline of an ordinary spur rack when viewed from one side. The sheet material to be punched depends appropriately upon the intended use of the rack (1) to be manufactured, and thin plate material made of metals other than iron, resin, or the like may be adopted depending upon the intended use.

In the thin-plate lamination step as described above, the plurality of thin plates (3) (nine plates in an embodiment) produced in the preceding thin-plate production step are laminated with each other such that positions of adjacent sets of rack teeth (2) in the axial directions of the adjacent thin plates (3) are displaced from each other by a predetermined amount, and the plurality of laminated thin plates (3) are fixed together. For example, as shown in FIGS. 3 and 4, the plurality of thin plates (3) are laminated and fixed with each other in such a manner that: positions of the plurality of sets of rack teeth (2) of the laminated thin plates (3) are displaced from each other in the axial directions (indicated by the double-headed arrow (5)) by the predetermined amount; and the tooth traces of the plurality of sets of rack teeth (2) of the laminated thin plates (3) form a herringbone pattern. It is to be noted that, in FIG. 4, a plurality of sets of tooth tops of rack teeth (2) are emphasized by black-colored fills to clarify how the adjacent sets of rack teeth (2) are displaced from each other with respect to each pair of adjacent thin plates (3).

For a fixing method in the thin-plate lamination step described above, a variety of such methods may be adopted. One example is that the thin plates (3) may have adhesive applied to their respective contacting surfaces in advance, and the laminated thin plates (3), after the thin-plate lamination step, may be caused to closely contact each other at a predetermined pressure to be fixed without relative displacement therebetween. Another example is that the laminated thin plates (3), after the thin-plate lamination step, may be perforated with a through hole in a thickness direction, and fastened by tightening a bolt inserted into the through hole with a nut to be fixed without relative displacement therebetween.

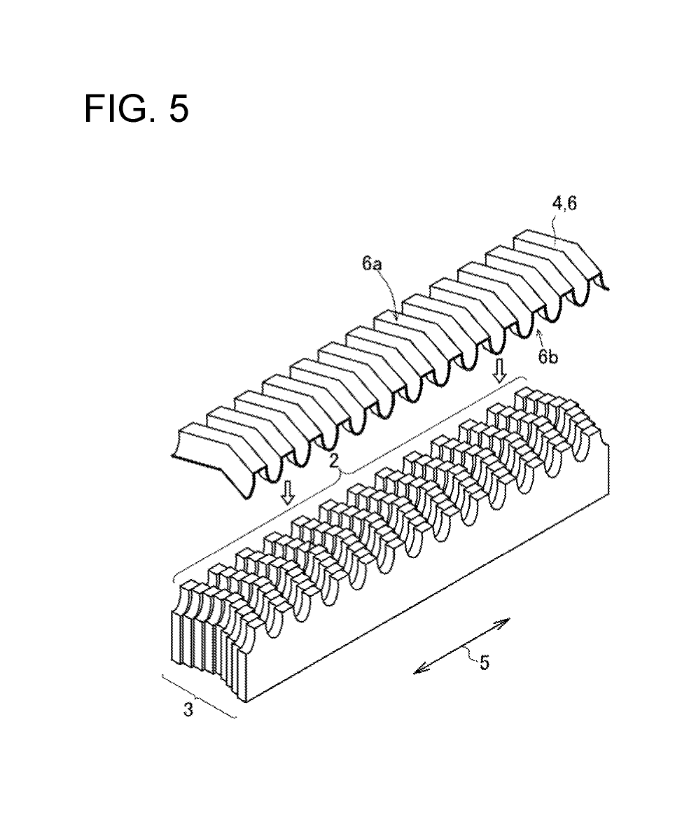

In the cover-adhesion step, a cover (6) made of fibers (4) impregnated with rubber or resin is adhered to the plurality of sets of rack teeth (2) of the laminated thin plates (3) so as to cover the plurality of sets of rack teeth (2). As shown in FIG. 5, the cover (6) has an outer surface (6a) formed in accordance with the rack-tooth shape of an ordinary herringbone rack, and an inner surface (6b) in a convex-concavo shape (not shown) corresponding to the concavo-convex shape made by the plurality of sets of rack teeth (2) of the laminated thin plates (3). As shown in FIGS. 3 and 4, unevenness is caused by a displacement along the axial directions between a plurality of sets of tooth flanks (2a) of rack teeth (2) immediately after the thin-plate lamination step, and such a problem of uneven appearance is solved by covering the plurality of sets of rack teeth (2) with the cover (6).

Through the operations in the above-described steps, the rack (1) shown in FIG. 1 is manufactured. Hereinafter, additional descriptions will be made of the fibers (4) impregnated with rubber or resin.

The fibers (4) may be made of, e.g., aramid fiber, nylon, urethane, cotton, silk, linen, acetate, rayon, fluorine-containing fiber, polyester, and the like, which are impregnated with rubber or resin. The fibers (4) may be in a shape of e.g., short fibers or long fibers.

By virtue of impregnating fibers with rubber or resin, rubber material or resin material is enabled to fill the gaps among the fibers and bond the fibers together, thereby allowing the fibers to serve as the cover (6). Further, by virtue of impregnating fibers with rubber or resin, the abrasion caused by friction between the fibers can be reduced, and still further, the resistance to abrasion on the cover (6) caused by friction between the cover (6) and a pinion gear can be improved.

The rubber is required to be that with which the fibers can be impregnated. As such types of rubber, the followings may be used in a neat form or in a form denatured in various ways: e.g., urethane rubber, nitrile rubber, silicon rubber, fluororubber, acrylic rubber, ethylene-propylene rubber, butyl rubber, isoprene rubber, chlorinated polyethylene rubber, epichlorohydrin rubber, hydrogenated nitrile rubber, chloroprene rubber, polybutadiene rubber, styrene-butadiene rubber, natural rubber, and the like. Each of these types of rubber may be used alone, or a plurality of types of rubber selected therefrom may be used in a blended form. Further, the rubber may contain appropriate amounts of traditional compounding ingredients for rubber, such as vulcanizing agent, vulcanizing accelerator, antioxidant, softener, plasticizer, filler, colorant, and the like. Still further, the above types of rubber may be replaced by or combined with thermoplastic or thermosetting resin such as acrylic resin, polyester resin, urethane resin, vinyl chloride resin, polypropylene, polycarbonate, polyethylene terephthalate resin, fluorine resin, polyethylene, acrylonitrile-styrene resin, acrylonitrile-butadiene-styrene resin, polystyrene resin, polyvinyl chloride, polyvinylidene chloride, polyvinyl acetate, nylon, alkyd resin, phenolic resin, epoxy resin, polyphenylene sulfide resin, and the like.

When impregnating fibers with rubber or resin as described above, it is preferable that the rubber or resin be dissolved by a solvent or another means into a liquid state before dipping the predetermined fibers (short fibers, long fibers, fabric) in the liquid. As a precursor of the cover (6) to be adhered to the plurality of sets of rack teeth (2), the sheet-like fabric made of the fibers may be used. This fabric is impregnated with rubber or resin in the same way as described above.

The fabric may be, e.g., non-woven fabric made of irregularly tangled fibers, regularly-formed woven, knitted fabric, or the like. These fabrics are characterized by facilitating impregnation (easier handling) with rubber and the like because these fabrics are in sheet form. The woven fabric may be made in a plain weave, satin weave, twill weave, or the like

### Advantageous Effects Achieved by Embodiments

According to the rack manufacturing method as an embodiment, the thin plates (3) are laminated so that their respective sets of rack teeth (2) can be displaced from each other in the axial directions, thereby enabling the formation of racks in arbitrary shapes such as herringbone, and as a result, it becomes easy to manufacture racks in complicated shapes, such as herringbone racks, which have been difficult thus far to manufacture.

For the rack (1) as an embodiment, due to the state where the plurality of laminated thin plates (3) are displaced from each other in the axial directions, unevenness is caused between a plurality of sets of tooth flanks (2a) of rack teeth (2). Therefore, it is undesirable that, if the rack (1) without covering the plurality of sets of rack teeth (2) is used in combination with an ordinary herringbone pinion, excessive abrasion of a plurality of sets of tooth edges (2b) of rack teeth (2) is caused by the unevenness between the plurality of sets of tooth flanks (2a). However, this problem can be solved by the rack (1) as an embodiment because the plurality of sets of rack teeth (2) are covered, and as a result, their relevant tooth edges (2b) are covered with the cover (6) having highly-improved abrasion and friction resistance.

According to the rack (1) as an embodiment, the plurality of sets of rack teeth (2) are covered with a member having highly-improved abrasion and friction resistance (the cover (6) made of fibers (4) impregnated with rubber or resin), which results in a rack-and-pinion mechanism obtained by engaging the rack (1) and a herringbone pinion capable of reducing tooth-hit noise as well as frictional resistance generated between the rack (1) and the herringbone pinion.

### Modified Examples of Embodiments

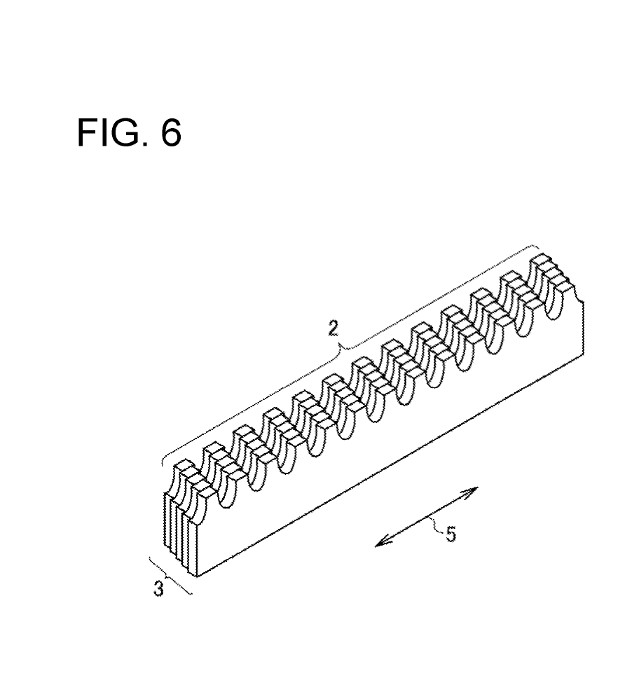

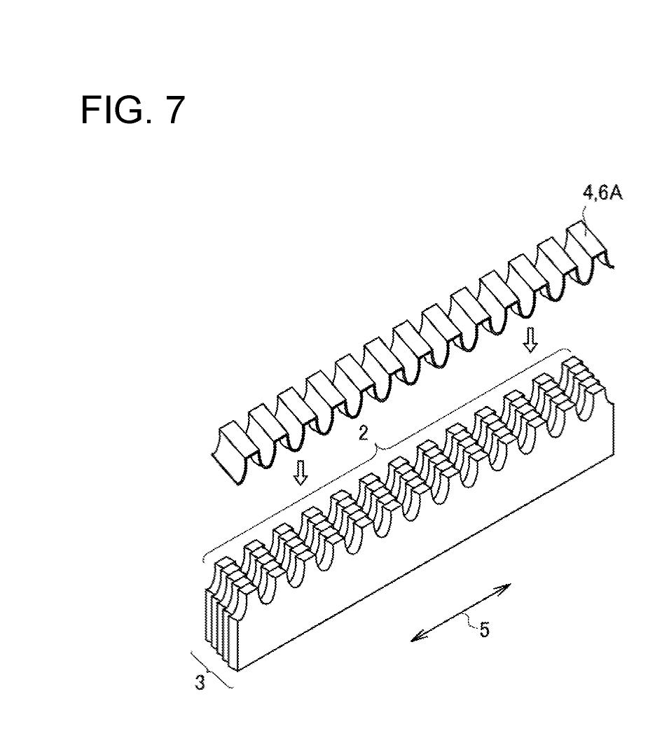

Above-described embodiments according to the present disclosure are described with respect to examples of how to manufacture herringbone racks; however, embodiments may be further extended to such an extent that, for example, by changing a displacement between the plurality of sets of rack teeth (2) of the plurality of thin plates (3) in the axial directions in the thin-plate lamination step, it becomes easy to manufacture any sort of racks or racks with any tooth form. For example, in the thin-plate lamination step, by laminating and fixing the thin plates (3) with each other such that their respective sets of rack teeth (2) are displaced from each other in the axial directions to form a helical pattern as shown in FIG. 6, and by causing the plurality of sets of rack teeth (2) of the laminated and fixed thin plates (3) to be covered and adhered with a cover (6A) made of fabric (4) impregnated with rubber or resin having a shape corresponding to the rack teeth (2) as shown in FIG. 7, the helical rack of low tooth-hit noise and of highly-improved abrasion and friction resistance can be manufactured.

Further, the racks as above-described embodiments are obtained by adhering covers (6), (6A) made of fibers (4) impregnated with rubber or resin to the plurality of sets of rack teeth 2 of the laminated thin plates (3); however, embodiments may be further extended to such an extent that, for example, racks without any covers such as covers (6), (6A) shown in FIGS. 3 and 6 may be used as they are or may be used after modified in some way.

Still further, in the rack manufacturing method as above-described embodiments, the covers (6), (6A) of fibers (4) impregnated with rubber or resin cover the plurality of sets of rack teeth 2 as a whole; however, embodiments may be further extended to such an extent that, for example, covers do not cover the plurality of sets of rack teeth (2) as a whole but cover at least the limited part (e.g., tooth flanks (2a) and the like) of the plurality of sets of rack teeth (2), which limited part are indicative of a part supposed to contact a pinion gear.

Still further, in above-described embodiments, the fibers (4) impregnated with rubber or resin may be replaced with rubber or resin having incorporated therein short fibers.

Specific constructions according to the present disclosure are not limited to embodiments described above with reference to the drawings. The scope of the present disclosure is not encompassed by the above explanations of embodiments but particularly pointed out by the claims, and the equivalents of the claim recitations as well as all the modifications within the scope of the claims fall within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### REFERENCE NUMERALS

1 Rack

2 Rack teeth

3 Thin plates

4 Fibers impregnated with rubber or resin (an abrasion-resistant and friction-resistant member)

What is claimed is:

1. A rack, comprising
a plurality of thin plates laminated with each other, wherein:
each of the plurality of thin plates is formed with a set of rack teeth; and
adjacent thin plates, which are laminated adjacently to each other, of the plurality of thin plates are fixed together such that respective rack-tooth positions of the adjacent thin plates are displaced from each other in axial directions of adjacent sets of rack teeth.

2. The rack according to claim 1, wherein a plurality of sets of rack teeth are covered with an abrasion-resistant and friction-resistant member.

3. A rack manufacturing method comprising the steps of:
laminating a plurality of thin plates, each of which is formed with a set of rack teeth, with each other; and
fixing a plurality of laminated thin plates together such that respective rack-tooth positions of adjacent thin plates, which are laminated adjacently to each other, of the plurality of laminated thin plates are displaced from each other in axial directions of adjacent sets of rack teeth.

4. The rack manufacturing method according to claim 3, further comprising the step of:
covering a plurality of sets of rack teeth of the plurality of laminated thin plates, respectively, with an abrasion-resistant and friction-resistant member.
